(19) United States
(12) Patent Application Publication
(10) Pub. No.: US 2014/0362455 A1
(43) Pub. Date: Dec. 11, 2014

(54) IMAGING LENS AND IMAGING APPARATUS INCLUDING THE SAME

(71) Applicant: FUJIFILM Corporation, Tokyo (JP)

(72) Inventors: Ping SUN, Saitama-ken (JP); Katsuhisa TSUTSUMI, Saitama-ken (JP); Kazunori ONO, Saitama-ken (JP); Michio CHO, Saitama-ken (JP)

(21) Appl. No.: 14/466,043

(22) Filed: Aug. 22, 2014

Related U.S. Application Data
(63) Continuation of application No. PCT/JP2013/000930, filed on Feb. 20, 2013.

(30) Foreign Application Priority Data
Feb. 22, 2012 (JP) 2012-035921

(51) Int. Cl. G02B 9/64; G02B 13/00

(52) U.S. Cl. CPC G02B 9/64; G02B 13/0015
USPC 359/740

(57) ABSTRACT

The imaging lens substantially consists of a front group having positive refractive power, an aperture stop, a rear group having positive refractive power in this order from the object side. The front group substantially consists of a lens having a negative meniscus shape with a convex surface toward the object side, a negative lens, and a positive lens in this order from the object side. The rear group substantially consists of a positive lens, a negative lens, a positive lens, and a positive lens in this order from the object side. In the case that the Abbe numbers with respect to the d-line of the first lens and the second lens from the object side in the front group are respectively ν1 and ν2, conditional expressions (1) and (2) below are satisfied:

10.0<ν2−ν1 (1)

40<ν2 (2).

### CROSS-REFERENCE TO RELATED APPLICATIONS

This application is a Continuation of PCT International Application No. PCT/JP2013/000930 filed on Feb. 20, 2013, which claims priority under 35 U.S.C. §119(a) to Japanese Patent Application No. 2012-035921 filed Feb. 22, 2012. The above application(s) is hereby expressly incorporated by reference, in its entirety, into the present application.

### BACKGROUND OF THE INVENTION

1. Technical Field

The present invention relates to an imaging lens and an imaging apparatus provided with this imaging lens, and more particularly to an imaging lens that can be suitably used for digital cameras, broadcasting cameras, surveillance cameras, vehicle mounted cameras and the like as well as an imaging apparatus provided with the imaging lens.

2. Description of the Related Art

In recent years, solid imaging elements to be mounted on cameras in the aforementioned fields have been miniaturized and have increased the number of pixels. Accordingly, imaging lenses also have been demanded to be miniaturized and have higher performance. In contrast, there is demand for the imaging lenses used for surveillance cameras, vehicle mounted cameras and the like to have a small F-number and have a wider angle.

For example, the imaging lens disclosed in Patent Document 1 (Japanese Unexamined Patent Publication No. 2000-019391) below is known as an imaging lens that can be used with solid imaging elements. Patent Document 1 discloses an imaging lens of a seven-lens configuration in which a front group having negative refractive power, an aperture stop, and a rear group having positive refractive power are arranged. The examples of imaging lenses having a wider angle of view include the imaging lenses disclosed in the following Patent Documents 2 and 3 (Japanese Unexamined Patent Publication No. 7(1995)-218826 and Japanese Patent Publication No. 4 (1992)-020161), for example. Patent Document 2 discloses a retro focus type lens that substantially consists of a front group having positive refractive power and composed of four lenses, an aperture stop, a rear group having positive refractive power and composed of three lenses. Patent Document 3 discloses a lens system of a seven-lens configuration in which two negative meniscus lenses with a convex surface toward the object side, a positive lens, a cemented lens constituted by a positive lens and a negative lens together, and two positive lenses are arranged in this order from the object side.

### SUMMARY OF THE INVENTION

The lens system disclosed in Patent Document 1, however, has an F-number of 3.2 which is large and has a full angle of view of 64° which is small. The lens system disclosed in Patent Document 2 has a small F-number but a full angle of view of 85° which is not sufficient. The lens system disclosed in Patent Document 3 has a small F-number and a wider angle of view, but the total length thereof is eight times as long as the focal length thereof and there is room for improvement in respect of performance. For example, in the case that the lens system is used in combination with solid imaging elements, lateral chromatic aberration is required to be favorably corrected.

The present invention has been developed in view of the above circumstances. It is an object of the present invention to provide a compact imaging lens having a smaller F-number, a wider angle, and a higher optical performance in which various aberrations including lateral chromatic aberration are favorably corrected; and an imaging apparatus including the imaging lens.

An imaging lens of the present invention substantially consists of a front group having positive refractive power, an aperture stop, and a rear group having positive refractive power;

the front group substantially consists of a negative meniscus lens with a convex surface toward the object side, a negative lens, and a positive lens in this order from the object side;

the rear group substantially consists of a positive lens, a negative lens, a positive lens, and a positive lens in this order from the object side; and conditional expressions (1) and (2) below are satisfied:

10.0<ν2−ν1 (1)

40<ν2 (2),

where
ν1: the Abbe number with respect to the d-line of the negative meniscus lens, and
ν2: the Abbe number with respect to the d-line of the second negative lens from the object side of the front group.

It is preferable for the imaging lens of the present invention to satisfy one of conditional expressions (3) through (7) or an arbitrary combination thereof:

0.30<f/f1<0.80 (3)

0.20<f1/f2<1.30 (4)

0.20<(R1−R2)/(R1+R2)<0.60 (5)

0.90<Dair/f<2.30 (6)

9.0<(Navg−1.5)×νavg<13.0 (7),

where
f: the focal length of the entire system,
f1: the focal length of the front group,
f2: the focal length of the rear group,
R1: the radius of curvature of the object-side surface of the negative meniscus lens on the most object side in the front group,
R2: the radius of curvature of the image-side surface of the negative meniscus lens on the most object side in the front group,
Dair: the longest air interval within the entire system,
Navg: the mean of the refractive indices with respect to the d-line of all of the lenses in the entire system, and
νavg: the mean of the Abbe numbers with respect to the d-line of all of the lenses in entire system.

It is more preferable for the imaging lens of the present invention to satisfy each of conditional expressions (1′) through (7′) below instead of the aforementioned conditional expressions (1) through (7):

15.0<ν2−ν1 (1′)

56<ν2 (2′)

0.30<f/f1<0.60 (3′)

0.50<f1/f2<1.10 (4′)

0.25<(R1−R2)/(R1+R2)<0.40 (5′)

1.0<Dair/f<2.0 (6′)

10.0<(Navg−1.5)×νavg<11.0 (7′).

In the imaging lens of the present invention, it is preferable for a first positive lens and a second negative lens from the object side in the rear group to be cemented together.

Further, in the imaging lens of the present invention, it is preferable for a full angle of view to exceed 90°.

Note that the expression “substantially” of “substantially consists of a front group . . . ” intends to mean that the imaging lens of the present invention may include lenses substantially without any refractive power; optical elements other than lenses such as aperture stops, cover glasses, filters, and the like; lens flanges; lens barrels; imaging elements; and mechanical components such as image stabilization mechanisms; in addition to the constituent elements listed above. The same applies to the other expressions “substantially” described above.

Note that the surface shapes, the signs of the refractive powers, radii of curvature of the above lens in the imaging lens of the present invention described above should be considered in paraxial regions if aspheric surfaces are included therein. Further, the sign of the radius of curvature is positive in the case that a surface shape is convex on the object side, and negative in the case that the surface shape is convex on the image side.

An imaging apparatus of the present invention is provided with the imaging lens of the present invention.

According to the present invention, a lens system in which a positive front group, an aperture stop, and a positive rear group are arranged in this order from the object side is configured in such a manner that the lens system is composed of seven lenses; a power arrangement, and the like of lenses which constitute the front group and the rear group is set in detail; and predetermined conditional expressions are satisfied. Thereby, a compact imaging lens having a small F-number, a wider angle of view, and a higher optical performance in which various aberrations including lateral chromatic aberration are favorably corrected can be provided, as well as an imaging apparatus equipped with the imaging lens.

### BRIEF DESCRIPTION OF THE DRAWINGS

FIG. 1 is a cross-sectional view illustrating the lens configuration of an imaging lens of Example 1 of the present invention.

FIG. 2 is a cross-sectional view illustrating the lens configuration of an imaging lens of Example 2 of the present invention.

FIG. 3 is a cross-sectional view illustrating the lens configuration of an imaging lens of Example 3 of the present invention.

A through E of FIG. 4 respectively illustrate aberration diagrams of the imaging lens of Example 1 of the present invention.

A through E of FIG. 5 respectively illustrate aberration diagrams of the imaging lens of Example 2 of the present invention.

A through E of FIG. 6 respectively illustrate aberration diagrams of the imaging lens of Example 3 of the present invention.

FIG. 7 is a diagram for explaining an arrangement of the imaging apparatus according to the present invention.

### DESCRIPTION OF THE PREFERRED EMBODIMENTS

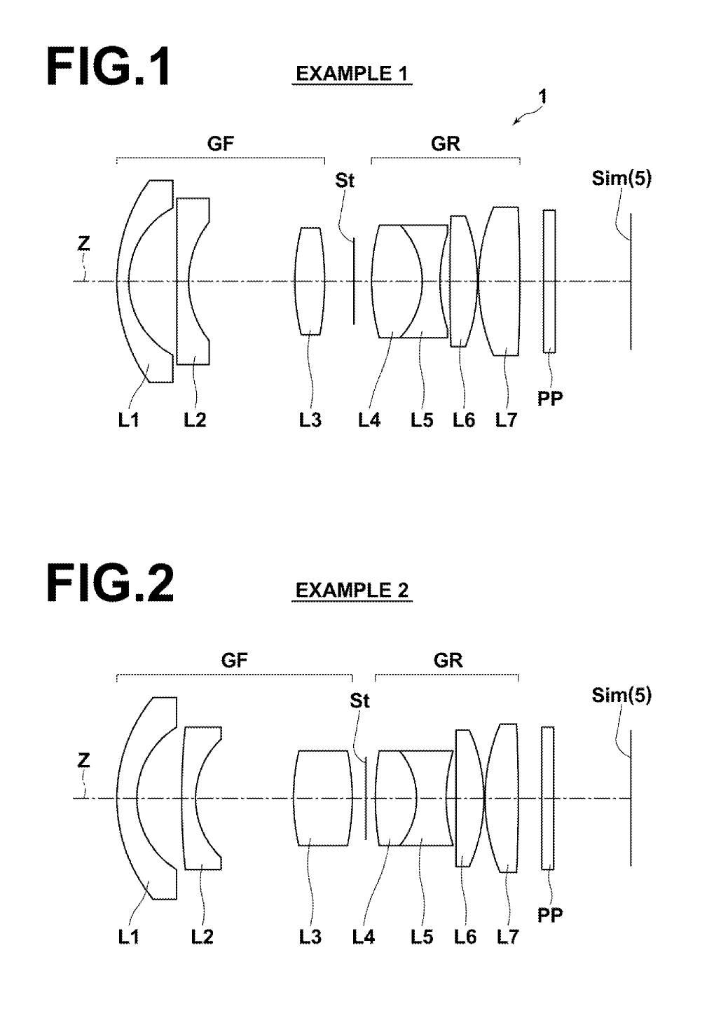

Hereinafter, embodiments of the present invention will be described in detail with reference to the accompanying drawings. Each of FIGS. 1 through 3 is a cross-sectional view of the imaging lens according to the embodiments of the present invention. FIGS. 1 through 3 corresponds to Example 1 through 3 to be described later, respectively. In FIGS. 1 through 3, the left side is the object side, and the right side is the image side. Since the basic configurations illustrated in FIGS. 1 through 3 and the manners in which the configurations are illustrated therein are all the same, a description will be given mainly with reference to the configuration shown in FIG. 1 as a representative example.

The imaging lens 1 according to the embodiments of the present invention is a fixed focus optical system in which a front group GF having positive refractive power as a whole, an aperture stoop St, and a rear group GR having positive refractive power as a whole are arranged in this order along the optical axis Z from the object side. The aperture stop St shown in FIG. 1 does not necessarily represent the size or shape thereof, but the position thereof on the optical axis Z. The front group GF of the imaging lens 1 shown in the example of FIG. 1 has lenses L1 through L3 arranged in this order from the object side, and the rear group GR has lenses L4 through L7 arranged in this order from the object side.

When an imaging lens is mounted onto an imaging apparatus, it is presumed that the imaging apparatus is configured to include a cover glass for protecting imaging elements, various types of filters, such as a low-pass filter, an infrared cut filter, and the like as appropriate according to the specifications of the imaging apparatus. Accordingly, FIG. 1 illustrates an example in which a plane parallel optical member PP that presumes such cover glass and filters is provided between the most-image-side lens surface and an image surface Sim.

FIG. 1 also shows the imaging element 5 disposed at the image surface Sim of the imaging lens 1, taking the case of applying the imaging lens to an imaging apparatus into consideration. Although FIG. 1 simply shows the imaging element 5, the imaging element 5 is actually disposed such that the imaging surface of the imaging element 5 matches the image surface Sim. The imaging element 5 captures an optical image formed by the imaging lens 1 and converts the image into an electric signal, and a CCD (Charge Coupled Device), a CMOS (Complementary Metal Oxide Semiconductor), or the like may be employed as the imaging element 1, for example.

The imaging lens 1 of the present embodiment is configured in such a manner that a front group G is composed of a negative meniscus lens with a convex surface toward the object side, a negative lens, and a positive lens in this order from the object side; and a rear group G is composed of a positive lens, a negative lens, a positive lens, and a positive lens in this order from the object side.

By making both the front group GF and the rear group GR positive lens groups, the total length of the lens system can be shortened. Further, by disposing the aperture stop St approximately in the middle of the lens system, the heights of rays at the most-object-side lens and the most-image-side lens where the height of rays is likely to be great can be suppressed so that lens diameters can be small.

By disposing a negative meniscus lens with a convex surface toward the object side on the most object side of the entire system, a wider angle of view can be advantageously obtained. Further, by making the power arrangement within the front group GF a retro focus type in which negative, negative, and positive lenses are arranged in this order from the object side, a wider angle of view can be more advantageously obtained.

In the rear group GR, by making the most-object-side lens, i.e., a lens L4, which is immediately adjacent to the aperture stop St toward the image side thereof, a positive lens; a converging effect can be administered on a light flux, which pass through the aperture stop St and is inclined to diverge, and miniaturization will be advantageously achieved. Further, disposing two positive lenses on the most image side of the entire system, positive refractive power of the rear group GR can be shared therebetween and spherical aberration will be advantageously corrected favorably.

A second lens from the object side in the front group GF may be a plano-concave lens or a negative meniscus lens. It is preferable for the most-image-side lens in the front group GF to be a biconvex lens so as to obtain a small-size configuration and secure positive refractive power required for the front group GF.

It is preferable for a first positive lens and a second negative lens from the object side in the rear group GR to be cemented together. In the example of FIG. 1, a lens L4 and a lens L5 are cemented together. By cementing these lenses together, longitudinal chromatic aberration will be favorably corrected without making various aberrations worse. Further, it is preferable for a first lens and a second lens from the object side of the rear group GR to respectively be a biconvex lens and a biconcave lens.

The imaging lens 1 of the present embodiment is configured to satisfy conditional expressions (1) and (2) below:

10.0<ν2−ν1 (1)

40<ν2 (2),

where
ν1: the Abbe number with respect to the d-line of the negative meniscus lens on the most object side in the front group, and
ν2: the Abbe number with respect to the d-line of the second negative lens from the object side in the front group.

If the value of ν2−ν1 is not more than the lower limit defined by conditional expression (1), lateral chromatic aberration in a blue color wavelength range of the F-line (wavelength: 486.13 nm) and the like will be more inclined to be over-corrected. If the value of ν2 is not more than the lower limit defined by conditional expression (2), lateral chromatic aberration in the blue color wavelength range of the F-line and the like will be more inclined to be under-corrected. By configuring the Abbe numbers of first and second lenses from the object side, of which the height of rays of off-axis rays is high, to satisfy conditional expressions (1) and (2), the lateral chromatic aberration can be favorably corrected.

Moreover, it is preferable for the imaging lens of the present invention to satisfy one of conditional expressions (3) through (7) below or an arbitrary combination thereof. It is preferable for the configuration given below to be selectively included as appropriate, according to the items required of the imaging lens.

0.30<f/f1<0.80 (3)

0.20<f1/f2<1.30 (4)

0.20<(R1−R2)/(R1+R2)<0.60 (5)

0.90<Dair/f<2.30 (6)

9.0<(Navg−1.5)×νavg<13.0 (7),

f: the focal length of the entire system,
f1: the focal length of the front group,
f2: the focal length of the rear group,
R1: the radius of curvature of the object-side surface of the negative meniscus lens on the most object side in the front group,
R2: the radius of curvature of the image-side surface of the negative meniscus lens on the most object side in the front group,
Dair: the longest air interval within the entire system,
Navg: the mean of the refractive indices with respect to the d-line of all of the lenses in the entire system, and νavg: the mean of the Abbe numbers with respect to the d-line of all of the lenses in entire system.

If the value of f/f1 is not more than the lower limit defined by conditional expression (3), the total length of the lens system will be increased. If the value of f/f1 is not less than the upper limit defined by conditional expression (3), it will be difficult to widen the angle of view. By satisfying conditional expression (3), the lens system will be advantageously configured to have a wider angle of view while suppressing an increase in the total length thereof.

If the value of f1/f2 is not more than the lower limit defined by conditional expression (4), it will be difficult to widen the angle of view. If the value of f1/f2 is not less than the upper limit defined by conditional expression (4), the total length will be increased. By satisfying conditional expression (4), the lens system can be advantageously configured in such a manner that the refractive power of the front group GF and the rear group GR can be balanced and a wider angle of view can be obtained while suppressing an increase in the total length thereof.

If the value of (R1−R2)/(R1+R2) is not more than the lower limit defined by conditional expression (5), spherical aberration will be inclined to be over-corrected. If the value of (R1−R2)/(R1+R2) is not less than the upper limit defined by conditional expression (5), spherical aberration will be inclined to be under-corrected and it will be difficult to correct longitudinal chromatic aberration. By satisfying conditional expression (5), spherical aberration and longitudinal chromatic aberration will be advantageously corrected favorably.

If the value of Dair/f is not more than the lower limit defined by conditional expression (6), an optical system with a large F-number or an optical system with a small angle of view will be obtained. If the value of Dair/f is not less than the upper limit defined by conditional expression (6), the total length of the lens system will be increased or it will be difficult to favorably correct various aberrations.

The air interval Dair in conditional expression (6) refers to the distance between lens surfaces which are adjacent to each other with air therebetween. It is preferable for the longest air interval in the entire system to be between the lens L2 and the lens L3 so as to obtain a small-sized configuration with a small number of lenses and achieve a wider angle and an excellent aberration correction, as shown in the example of FIG. 1.

If the value of (Navg−1.5)×νavg is not more than the lower limit defined by conditional expression (7), spherical aberration and longitudinal chromatic aberration will be inclined to be over-corrected. If the value of (Navg−1.5)×νavg is not less than the upper limit defined by conditional expression (7), spherical aberration will be inclined to be under-corrected or lateral chromatic aberration will be inclined to be over-corrected.

It is more preferable for each of conditional expressions (1′) through (7′) below to be satisfied instead of conditional expressions (1) through (7) taking the aforementioned circumstances into consideration:

15.0<ν2−ν1 (1′)

56<ν2 (2′)

0.30<f/f1<0.60 (3′)

0.50<f1/f2<1.10 (4′)

0.25<(R1−R2)/(R1+R2)<0.40 (5′)

1.0<Dair/f<2.0 (6′)

10.0<(Navg−1.5)×νavg<11.0 (7′).

It is preferable for the imaging lens of the present embodiment to be configured in such a manner that the full angle of view exceeds 90°. Thereby, the imaging lens can be suitably used for surveillance cameras which require a wide view, vehicle mounted cameras, and the like.

Next, Numerical Examples of the imaging lens of the present invention will be described.

### Example 1

A cross-sectional view of the imaging lens of Example 1 is shown in FIG. 1. Since the manner it is shown is as described above, redundant descriptions thereof will be omitted.

The schematic configuration of the imaging lens of the Example 1 is as described below. That is, the imaging lens substantially consists of a front group GF having positive refractive power; an aperture stop St; and a rear group GR having positive refractive power in this order from the object side. The front group GF substantially consists of three lenses, i.e., a lens L1 having a negative meniscus shape with a convex surface toward the object side, a lens L2 having a plano-concave shape with a planar surface toward the object side, and a lens L3 having a biconvex shape in this order from the object side. The rear group GR substantially consists of four lenses, i.e., a lens L4 having a biconvex shape, a lens L5 having a biconcave shape, a lens L6 having a biconvex shape, and a lens L7 having a biconvex shape in this order from the object side. The lenses L4 and L5 are cemented to each other, and the other lenses are not cemented to each other, but are single lenses. All of the lenses L1 through L7 are spherical lenses.

As the detailed configuration of the imaging lens in Example 1, lens data is shown in Table 1 and specifications are shown in Table 2. Column Si shows the i-th (i=1, 2, 3, . . . ) surface number, the value of i sequentially increasing from the surface on the object side of the constituent element at the most-object side, which is designated as 1, toward the image side. Column Ri shows the radius of curvature of the i-th surface (i=1, 2, 3, . . . ), and the sign of the radius of curvature is positive in the case that a surface shape is convex on the object side, and negative in the case that the surface shape is convex on the image side. Column Di shows the distances between i-th surfaces and (i+1)st surfaces along the optical axis Z. The lowest row of column Di shows the distance between the most-image-side surface shown in Table 1 and the image surface Sim.

Further, in Table 1, column Ndj show the refractive index of a j-th (j=1, 2, 3, . . . ) optical element with respect to the d-line (wavelength: 587.56 nm), the value of j sequentially increasing from the constituent element at the most object side, which is designated as 1, toward the image side. Column νdj shows the Abbe number of the j-th optical element with respect to the d-line. Note that the lens data also shows an aperture stop St and an optical member PP. Further, the column of the surface number of a surface corresponding to the aperture stop St indicates a surface number and the letters (St).

Table 2 shows specifications of the imaging lens in Example 1. In Table 2, f is the focal length of the entire system, Bf is the back focus (an air converted length), FNo. is the F-number, and ω is the half angle of view. The values shown in Table 2 are based on the d-line.

In each Table shown below, degrees are used as the unit of angles and mm is used as the unit of length, but other appropriate units may also be used, as optical systems are usable even when they are proportionally enlarged or miniaturized. Further, the numerical values of each Table shown below are rounded to a predetermined number of digits.

Values corresponding to conditional expressions (1) through (7) of the imaging lens of Example 1 are shown with those of the other Examples 2 and 3 in Table 7 to be shown later.

Example 1 Lens Data

| Si | Ri | Di | Ndj | νdj |
|---|---|---|---|---|
| 1 | 14.4943 | 1.00 | 1.77250 | 49.60 |
| 2 | 7.0045 | 4.08 | | |
| 3 | ∞ | 1.00 | 1.48749 | 70.23 |
| 4 | 8.0380 | 9.00 | | |
| 5 | 18.5277 | 2.53 | 1.83400 | 37.16 |
| 6 | −25.0380 | 2.50 | | |
| 7(St) | ∞ | 1.50 | | |
| 8 | 17.2726 | 4.30 | 1.61272 | 58.72 |
| 9 | −6.8940 | 1.50 | 1.80518 | 25.42 |
| 10 | 12.9554 | 0.84 | | |
| 11 | 204.1108 | 2.33 | 1.74320 | 49.34 |
| 12 | −15.2844 | 0.10 | | |
| 13 | 15.9819 | 3.50 | 1.74320 | 49.34 |
| 14 | −131.0387 | 2.00 | | |
| 15 | ∞ | 1.00 | 1.51633 | 64.14 |
| 16 | ∞ | 6.42 | | |

Example 1 Specification

| | |
|---|---|
| f | 6.2 |
| Bf | 9.1 |
| FNo. | 2.0 |
| ω[°] | 50.3 |

A through E of FIG. 4 respectively show aberration diagrams of spherical aberration, offense against the sine condition, astigmatism, distortion, lateral chromatic aberration of the imaging lens in Example 1. FNo. of spherical aberration and offense against the sine condition represents a F-number, the symbol “ω” in the other aberration diagrams represents a half angle of view. Each aberration diagram is with respect to the d-line (wavelength: 587.56 nm), but the spherical aberration diagrams also illustrates aberrations with respect to the C-line (wavelength: 656.27 nm), the F-line (wavelength: 486.13 nm) and the g-line (wavelength: 435.84 nm), and the lateral chromatic aberration diagrams illustrate aberrations with respect to the C-line and the F-line. In the astigmatism diagrams, the solid line illustrates astigmatism in the sagittal direction while the dotted line illustrates astigmatism in the tangential direction. A through E of FIG. 4 is for when the object distance is at infinity.

The manners in which Figures are illustrated, the symbols in each Table, the meanings thereof, and the manners in which they are shown with respect to the aforementioned Example 1 are the same as those for Examples 2 and 3 below, unless otherwise noted. Accordingly, redundant descriptions thereof will be omitted.

### Example 2

FIG. 2 is a cross-sectional view illustrating the lens configuration of an imaging lens of Example 2. The schematic configuration of the imaging lens in Example 2 is the same as that of Example 1 except for the points that the lens L2 has a negative meniscus shape with a convex surface toward the object side and that the lens L6 has a positive meniscus shape with a convex surface toward the image side. Tables 3 and 4 respectively show the lens data and specifications of the imaging lens in Example 2. A through E of FIG. 5 respectively show aberration diagrams of the imaging lens in Example 2.

Example 2 Lens Data

| Si | Ri | Di | Ndj | νdj |
|---|---|---|---|---|
| 1 | 13.2832 | 1.69 | 1.83481 | 42.73 |
| 2 | 7.0327 | 3.80 | | |
| 3 | 59.2447 | 1.18 | 1.51633 | 64.14 |
| 4 | 6.8424 | 8.30 | | |
| 5 | 17.5906 | 5.00 | 1.85026 | 32.27 |
| 6 | −19.1656 | 1.16 | | |
| 7(St) | ∞ | 0.80 | | |
| 8 | 24.1539 | 3.50 | 1.60300 | 65.44 |
| 9 | −6.2691 | 2.50 | 1.78472 | 25.68 |
| 10 | 13.7495 | 0.85 | | |
| 11 | −3311.8669 | 2.35 | 1.72916 | 54.68 |
| 12 | −13.9784 | 0.10 | | |
| 13 | 15.9458 | 2.82 | 1.72916 | 54.68 |
| 14 | −135.4447 | 2.00 | | |
| 15 | ∞ | 1.00 | 1.51633 | 64.14 |
| 16 | ∞ | 6.55 | | |

Example 2 Specification

| | |
|---|---|
| f | 6.2 |
| Bf | 9.2 |
| FNo. | 2.0 |
| ω[°] | 50.1 |

### Example 3

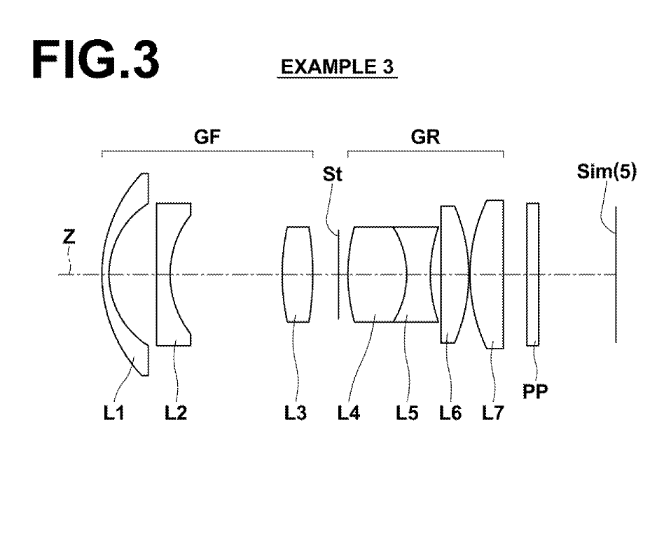

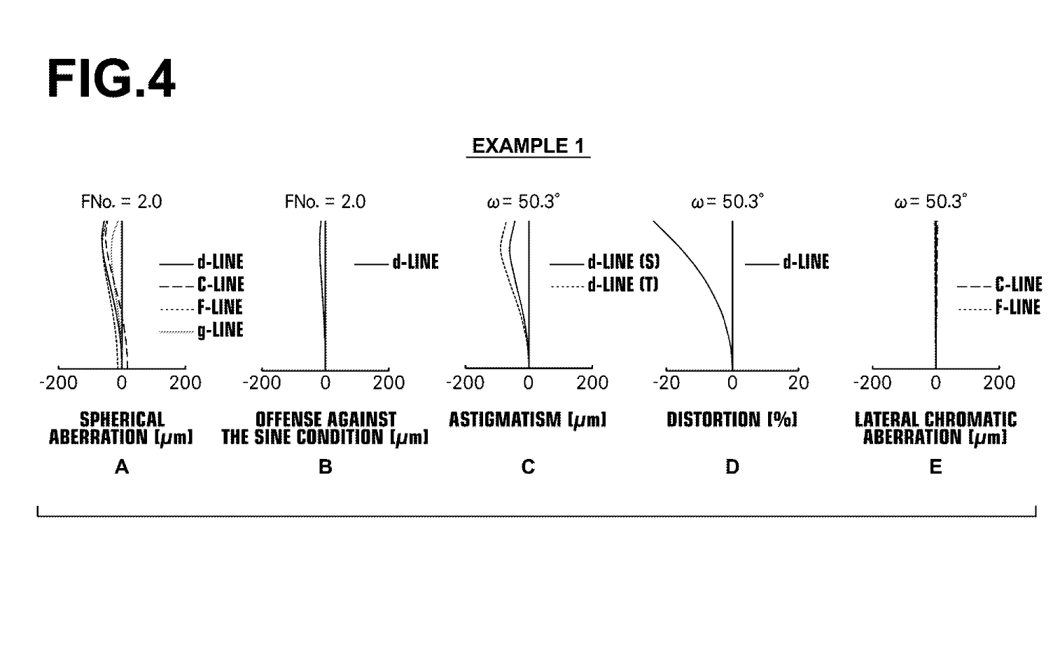

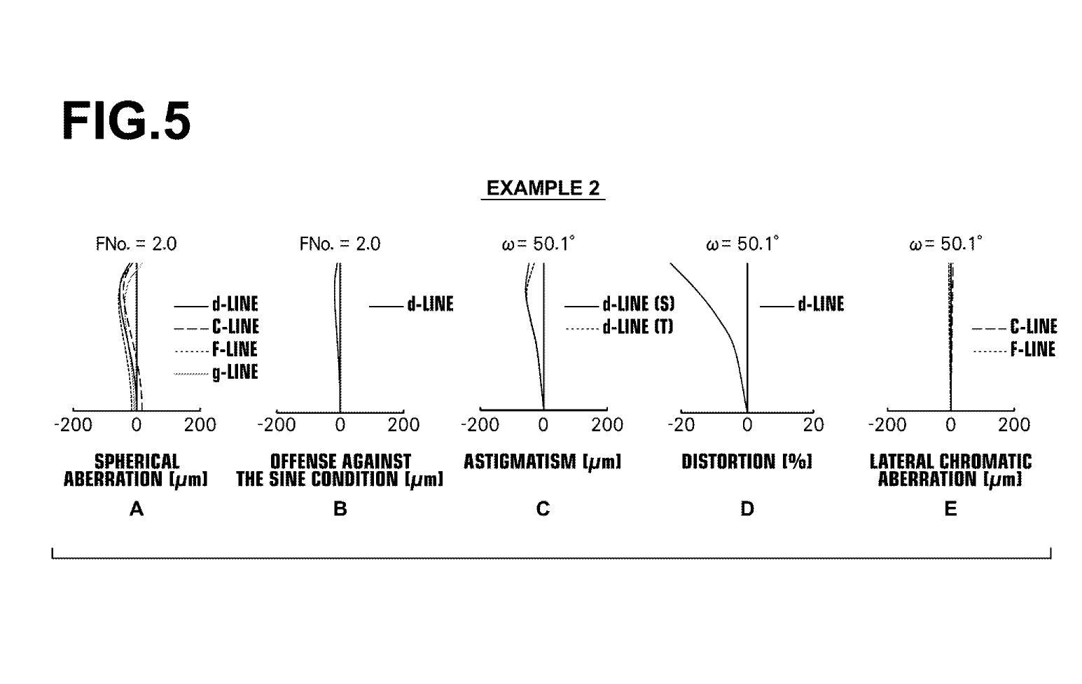

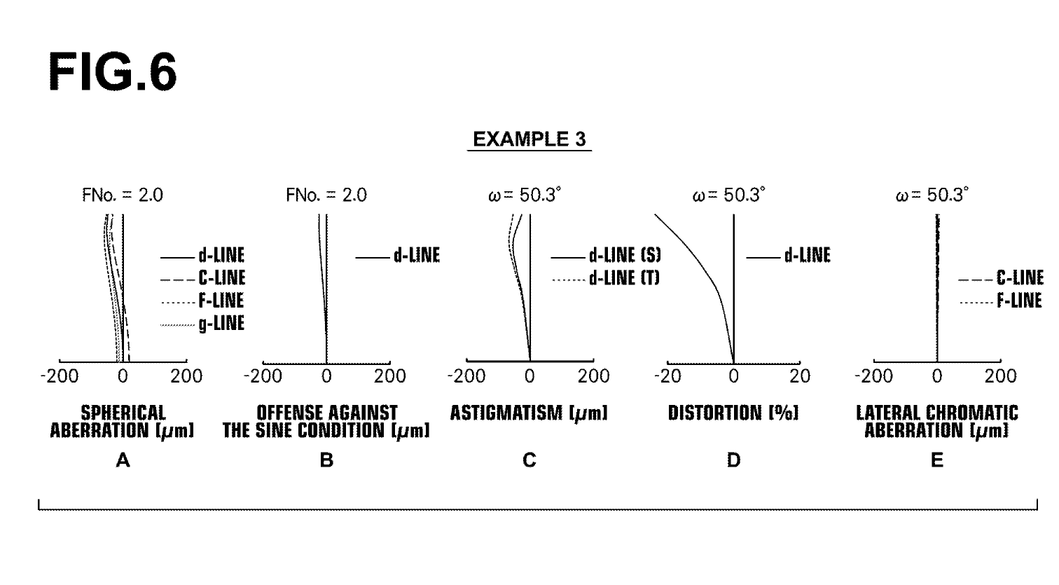

FIG. 3 is a cross-sectional view illustrating the lens configuration of an imaging lens of Example 3. The schematic configuration of the imaging lens in Example 3 is the same as that of Example 1 except for the points that the lens L6 has a plano-convex shape with a planar surface toward the object side and that the lens L7 has a plano-convex shape with a planar surface toward the image side. Tables 5 and 6 respectively show the lens data and specifications of the imaging lens in Example 3. A through E of FIG. 6 show aberration diagrams of the imaging lens in Example 3.

Example 3 Lens Data

| Si | Ri | Di | Ndj | νdj |
|---|---|---|---|---|
| 1 | 12.3973 | 0.60 | 1.83400 | 37.16 |
| 2 | 7.0566 | 4.04 | | |
| 3 | ∞ | 1.14 | 1.52249 | 59.84 |
| 4 | 8.0563 | 9.50 | | |
| 5 | 18.1129 | 2.59 | 1.80000 | 29.84 |
| 6 | −25.0276 | 2.20 | | |
| 7(St) | ∞ | 0.80 | | |
| 8 | 14.8894 | 4.98 | 1.61800 | 63.33 |
| 9 | −7.5286 | 2.00 | 1.84666 | 23.78 |
| 10 | 11.9452 | 0.91 | | |
| 11 | ∞ | 2.35 | 1.75500 | 52.32 |
| 12 | −14.3346 | 0.10 | | |
| 13 | 14.3478 | 2.83 | 1.75500 | 52.32 |
| 14 | ∞ | 2.00 | | |
| 15 | ∞ | 1.00 | 1.51633 | 64.14 |
| 16 | ∞ | 6.55 | | |

Example 3 Specification

| | |
|---|---|
| f | 6.2 |
| Bf | 9.2 |
| FNo. | 2.0 |
| ω[°] | 50.3 |

Table 7 shows values corresponding to conditional expressions (1) through (7) of the imaging lens in Examples 1 through 3 above. The values shown in Table 7 are based on the d-line.

| Conditional Expressions | | Example 1 | Example 2 | Example 3 |
|---|---|---|---|---|
| (1) | ν2 − ν1 | 20.63 | 21.41 | 22.68 |
| (2) | ν2 | 70.23 | 64.14 | 59.84 |
| (3) | f/f1 | 0.37 | 0.50 | 0.36 |
| (4) | f1/f2 | 0.97 | 0.67 | 0.95 |
| (5) | (R1 − R2)/(R1 + R2) | 0.35 | 0.31 | 0.27 |
| (6) | Dair/f | 1.45 | 1.33 | 1.52 |
| (7) | (Navg − 1.5) × νavg | 10.39 | 10.73 | 10.61 |

As can be found from the data described above, each of the imaging lenses of Examples 1 through 3 is configured to be compact, with seven lenses; has all spherical surfaces; and can be produced at low cost as well as having a F-number of 2.0 which is small and achieving a wider angle of view such that a full angle of view is not less than 100°. The imaging lens further has a higher optical performance with various aberrations including chromatic aberration corrected favorably. These imaging lenses can be suitably used for surveillance cameras, vehicle mounted cameras for photographing images in the front, side, and back of an automobile, and the like.

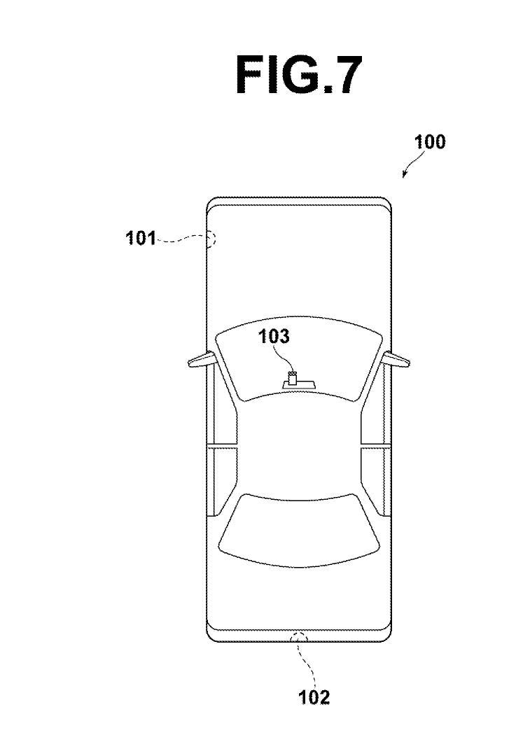

FIG. 7 shows the aspect of an automobile 100 on which the imaging apparatus provided with the imaging lens of the present embodiment is mounted, as a usage example. In FIG. 7, the automobile 100 is provided with an outside-vehicle camera 101 for photographing a blind angle range on the side surface of the passenger's side thereof, an outside-vehicle camera 102 for photographing a blind angle range behind the automobile 100, and an in-vehicle camera 103, which is provided on the back of a room mirror, for photographing the same visual field range as the driver's. The outside-vehicle cameras 101, 102, and the in-vehicle camera 103 correspond to the imaging apparatus according to the embodiment of the present invention, and are provided with the imaging lens according to the present embodiment of the present invention and an imaging element which converts an optical image formed by the imaging lens into an electric signal.

The present invention has been described with reference to the Embodiments and Examples. The present invention is not limited to the embodiments and the examples described above, and various modifications are possible. For example, values, such as the radius of curvature, the distances between surfaces, the refractive indices, the Abbe numbers of each lens element, and the like are not limited to the values in the numerical examples shown in the Tables, but may be other values.

The embodiment of the imaging apparatus was described with reference to the Figure of a camera as an example, in which the present invention is mounted on a four-wheeled vehicle. The present invention is not limited to this application and can be applied to vehicle mounted cameras for two-wheeled vehicles, portable terminal cameras, surveillance cameras, and the like, for example.

What is claimed is:

1. An imaging lens substantially consisting of a front group having positive refractive power, an aperture stop, and a rear group having positive refractive power;
the front group substantially consists of a negative meniscus lens with a convex surface toward the object side, a negative lens, and a positive lens in this order from the object side;
the rear group substantially consists of a positive lens, a negative lens, a positive lens, and a positive lens in this order from the object side;
a full angle of view exceeds 90°; and
conditional expressions (1) and (2) below are satisfied:
10.0<ν2−ν1 (1)
40<ν2 (2),
where
ν1: the Abbe number with respect to the d-line of the negative meniscus lens, and
ν2: the Abbe number with respect to the d-line of the second negative lens from the object side of the front group.

2. The imaging lens of claim 1, wherein conditional expression (1′) below is satisfied:
15.0<ν2−ν1 (1′).

3. The imaging lens of claim 1, wherein conditional expression (2′) below is satisfied:
56<ν2 (2′).

4. The imaging lens of claim 1, wherein conditional expression (3) is satisfied:
0.30<f/f1<0.80 (3),
where
f: the focal length of the entire system, and
f1: the focal length of the front group.

5. The imaging lens of claim 4, wherein conditional expression (3′) is satisfied:
0.30<f/f1<0.60 (3′).

6. The imaging lens of claim 1, wherein conditional expression (4) is satisfied:
0.20<f1/f2<1.30 (4),
where
f1: the focal length of the front group, and
f2: the focal length of the rear group.

7. The imaging lens of claim 6, wherein conditional expression (4′) is satisfied:
0.50<f1/f2<1.10 (4′).

8. The imaging lens of claim 1, wherein conditional expression (5) is satisfied:
0.20<(R1−R2)/(R1+R2)<0.60 (5),
where
R1: the radius of curvature of the object-side surface of the negative meniscus lens, and
R2: the radius of curvature of the image-side surface of the negative meniscus lens.

9. The imaging lens of claim 8, wherein conditional expression (5′) is satisfied:
0.25<(R1−R2)/(R1+R2)<0.40 (5′).

10. The imaging lens of claim 1, wherein conditional expression (6) is satisfied:
0.90<Dair/f<2.30 (6),
where
Dair: the longest air interval within the entire system, and
f: the focal length of the entire system.

11. The imaging lens of claim 10, wherein conditional expression (6′) is satisfied:
1.0<Dair/f<2.0 (6′).

12. The imaging lens of claim 1, wherein conditional expression (7) is satisfied:
9.0<(Navg−1.5)×νavg<13.0 (7),
where
Navg: the mean of the refractive indices with respect to the d-line of all of the lenses in the entire system, and
νavg: the mean of the Abbe numbers with respect to the d-line of all of the lenses in the entire system.

13. The imaging lens of claim 12, wherein conditional expression (7′) is satisfied:
10.0<(Navg−1.5)×νavg<11.0 (7′).

14. The imaging lens of claim 1, wherein a first positive lens and a second negative lens from the object side in the rear group are cemented together.

15. An imaging apparatus comprising the imaging lens of claim 1.
